(19) United States
(12) Patent Application Publication
(10) Pub. No.: US 2020/0265211 A1
(43) Pub. Date: Aug. 20, 2020

(54) FINGERPRINT DISTORTION RECTIFICATION USING DEEP CONVOLUTIONAL NEURAL NETWORKS

(71) Applicant: West Virginia University, Morgantown, WV (US)

(72) Inventors: Nasser M. Nasrabadi, Morgantown, WV (US); Jeremy M. Dawson, Fairmont, WV (US); Ali Dabouei, Morgantown, WV (US)

(21) Appl. No.: 16/791,757

(22) Filed: Feb. 14, 2020

Related U.S. Application Data
(60) Provisional application No. 62/805,423, filed on Feb. 14, 2019.

(51) Int. Cl. G06K 9/00; G06N 3/08; G06N 3/04; G06T 3/00

(52) U.S. Cl. CPC G06K 9/00013; G06N 3/08; G06K 9/00067; G06T 3/0068; G06N 3/04

(57) ABSTRACT

Various examples are provided for fingerprint distortion rectification. In one example, a method includes selecting a geometrically distorted fingerprint sample and generating a rectified fingerprint sample by rectifying geometric distortions from the geometrically distorted fingerprint sample by application of an estimated distortion field determined by a deep convolutional neural network (DCNN) trained previously on a database of synthetic, geometrically distorted fingerprint samples. In another example, a system includes a distortion rectification application that, when executed by processing circuitry, causes the processing circuitry to identify distortion parameters associated with a distorted fingerprint, the distortion parameters estimated from the distorted fingerprint by a DCNN and generate a rectified fingerprint from the distorted fingerprint, the rectified fingerprint generated using an inverse geometric transformation based upon the identified distortion parameters

### CROSS REFERENCE TO RELATED APPLICATIONS

This application claims priority to, and the benefit of, co-pending U.S. provisional application entitled “Fingerprint Distortion Rectification using Deep Convolutional Neural Networks” having Ser. No. 62/805,423, filed Feb. 14, 2019, which is hereby incorporated by reference in its entirety.

### BACKGROUND

The fingerprint is one of the most important biometric modalities due to its uniqueness and easy acquisition process. Leveraged by rapid advances in sensor technologies and matching algorithm development, automatic fingerprint recognition has been widely adopted as a highly accurate identification method. Elastic distortion of fingerprints has a negative effect on the performance of fingerprint recognition systems. This negative effect brings inconvenience to users in authentication applications. However, in the negative recognition scenario where users may intentionally distort their fingerprints, this can be a serious problem since distortion will prevent a recognition system from identifying malicious users.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flowchart illustrating an example for rectifying distorted fingerprints, including training and testing paths, in accordance with various embodiments of the present disclosure.

FIG. 2 illustrates examples of synthetic distorted fingerprint samples generated for training a deep convolutional neural network (DCNN) of FIG. 1, in accordance with various embodiments of the present disclosure.

FIGS. 3A-3C illustrate examples of ROC curves of three matching experiments for three databases, in accordance with various embodiments of the present disclosure.

FIGS. 4A and 4B illustrate examples of confusion matrices for two approaches: (a) the nearest neighbor method and (b) the proposed DCNN-based distortion estimation, in accordance with various embodiments of the present disclosure.

FIG. 5 illustrates examples of match scores for three pairs of normal and rectified fingerprints for the two approaches, in accordance with various embodiments of the present disclosure.

FIG. 6 is a schematic block diagram of one example of a system employed for fingerprint distortion rectification, in accordance with various embodiments of the present disclosure.

### DETAILED DESCRIPTION

Disclosed herein are various examples related to fingerprint distortion rectification. Current methods aimed at addressing the fingerprint distortion problem still have limitations. They are often not accurate because they estimate distortion parameters based on the ridge frequency map and orientation map of input samples, which are not reliable due to the distortion. Additionally, they are not efficient and require significant computation time to rectify the samples. In this disclosure, a rectification model can be developed based on a deep convolutional neural network (DCNN) to accurately estimate distortion parameters from the input image. Using a comprehensive database of synthetic distorted samples, the DCNN can learn to accurately estimate distortion bases ten times faster than the dictionary search methods used in the previous approaches. Evaluating the fingerprint distortion rectification using a DCNN on public databases of distorted samples showed that it can significantly improve the matching performance of distorted samples. Reference will now be made in detail to the description of the embodiments as illustrated in the drawings, wherein like reference numbers indicate like parts throughout the several views.

The operation of a typical fingerprint recognition system comprises three main steps or stages: preprocessing, pattern/feature processing, and scoring. In the preprocessing step, a raw fingerprint is enhanced to reduce noise, connect broken ridges and separate joined ridges. In the second step, exact ridge patterns are processed to extract local features, namely minutiae, from the enhanced image. In the final step, a match score between two fingerprint features is calculated by analyzing properties of minutiae (location, orientation, etc.) using local and global relationships between them.

Algorithms for fingerprint matching have advanced, resulting in the development of numerous and varied commercial fingerprint recognition systems. These algorithms perform well in identifying clean samples, but often fail to identify samples which are distorted. Consequently, recognizing dirty fingerprints is a challenging problem for fingerprint recognition systems. Most of the fingerprint matching algorithms are based on calculating the relative properties between features within a fingerprint, and then matching them with other fingerprints. However, distortion that can occur during the collection process changes the relative properties of fingerprint features and causes a notable decrease in recognition performance.

The two main types of recognition scenarios include positive and negative recognition. In the positive recognition scenario, the goal is user authentication, wherein the user cooperates with the recognition system in order to be recognized and obtain access to locations or systems. In contrast, the negative recognition scenario deals with an uncooperative user who is unwilling to be identified. Based on the recognition goal, the quality of the fingerprint can lead to different consequences. In the positive recognition scenario, low-quality fingerprints prevent legitimate users from being authenticated. Although this brings inconvenience, users learn to reduce distortion after several authentication attempts.

Serious consequences of low-quality fingerprints are tied with the negative recognition scenario in which users may deliberately decrease the quality of fingerprint to avoid being identified. Attempts to alter and damage fingerprints in order to impair identification have been reported by law enforcement officials. Hence, increasing fingerprint quality is a beneficial task in negative recognition systems. Additionally, it provides the added benefit of reducing the inconvenience of false rejection of valid users in positive recognition systems.

The quality of fingerprint samples can be deteriorated by many factors, either geometrically or photometrically. The primary cause of photometric degradation is artifacts on the finger or sensor, such as oil, moisture or markings from previous impressions. Photometric degradation in fingerprints has been widely investigated in terms of detection and compensation.

Fingers have cylindrical shape with relatively small radius compared to the ridge pattern size. Capturing fingerprint samples is a complex mapping from a 3D surface to a 2D image, since the finger is being pressed onto a platen on a sensor. This mapping differs for each impression, which is referred to as geometric distortion. Geometric distortion is related to mechanical properties, such as the force and torque a user applies to the finger in the acquisition process.

Different from photometric distortion, geometric distortion introduces translational and rotational error in the relative distances and orientations of local features. These relative distances and orientations of local features are the abstract identifiers of a user. In the presence of photometric distortion, the match score decreases since many minutiae may be missing, or false minutiae may be detected. In cases of severe geometric distortion, the match score decreases because the new composition of minutiae forms a completely different ID caused by the distortion. The issue causes more problems in negative recognition systems, since distorted samples are still of high quality compared to clean samples, but matching algorithms fail to recognize them.

Various approaches have been proposed to tackle the issue of geometric distortion in fingerprints. Designing specific acquisition hardware which detects distortion during recording procedure is one approach. The hardware can detect distorted samples using different techniques, such as measuring excessive force or the de-formation of the acquisition surface, and motion processing during capturing fingerprint video. The hardware can reject severely distorted records and ask the user to provide a new impression until the system requirements are satisfied.

Despite improvements in the recognition performance, there are certain drawbacks associated with the use of hardware-based distortion detection techniques: (i) they need specific sensors and additional capabilities; (ii) it is not possible to apply them on previously recorded samples; (iii) it makes the system weak against malicious users who have altered their finger tips and ridge patterns; (iv) it is merely detecting distortion, and there is no rectification process since the user is obligated to provide clean impressions.

Since geometric distortion essentially moves features in fingerprints, adding distortion tolerance to fingerprint matching has shown promising results in compensating for the distortion problem. Distortion can be modeled by different special transformations such as, e.g., rigid and thin plate spline (TPS). A discussion of TPS is presented in “Principal warps: Thin-plate splines and the decomposition of deformations” by F. L. Bookstein (IEEE Transactions on Pattern Analysis and Machine Intelligence, 11(6):567-585, 1989), which is hereby incorporated by reference in its entirety. Although rigid transformation is not powerful enough to model the complex properties of geometric distortion, combining a global rigid transform and a local tolerant window can provide improvements in matching distorted samples. TPS as a more complex transformation has been used to make matching algorithms tolerant to geometric distortion. However, compensating for distortion by adding tolerance to a fingerprint matcher inevitably results in a higher false positive match rate, and is highly dependent on estimating parameters of a complex transformation function.

A rectification technique based on learning a deformation pattern from the correspondence of ridge curvatures of the same finger in different impressions can be used. By computing average distortion based on the corresponding ridges, it is possible to estimate parameters of the TPS transformation. This method has shown improvement in matching distorted samples. However, the performance of the ridge curve correspondence method is highly dependent on the number of impressions of the same finger, and in most databases, there are not enough samples per class to provide such an estimation.

Based on the assumption that the ridge frequency within a normal fingerprint is constant, a mathematical method of distortion rectification can be introduced by equalizing the frequency map in distorted fingerprints. This method can improve matching performance, especially when applying equalization to both distorted and original samples before matching. Although the ridge frequency map has discriminative information, which is not constant within the whole fingerprint area, the approach offers two important accomplishments compared to previous work. First, it does not need any specific hardware design, and second, it is possible to apply the algorithm on a single fingerprint image. However, equalizing all ridge spacings in a fingerprint has the following limitations: (i) some identification information will be lost and the false positive match rate will increase; (ii) in severe distortion cases, ridges are mixed together, and it is not possible to equalize the spacing between them; and (iii) equalizing the ridge frequency map within the whole fingerprint introduces distortion in the ridge orientation map.

More recently, the Tsinghua distorted fingerprint database (“Detection and rectification of distorted fingerprints” by Si et al., IEEE Transactions on Pattern Analysis and Machine Intelligence, 37(3):555-568, March 2015, which is hereby incorporated by reference in its entirety) was collected by inducing 10 different types of force and torque to fingers during the fingerprint acquisition process. A statistical model for distortion can be implemented by computing minutiae displacements in distorted and corresponding original samples. In this method, the top two significant principal components of displacement are used to generate a dictionary of distorted samples. For each input sample, the ridge frequency and orientation maps can be computed and compared to a dictionary in order to find the nearest distorted template. The method shares all advantages of previous works, and it does not equalize the ridge frequency map. Therefore, discriminatory information of the frequency map is preserved, and the ridge orientation map is not distorted.

Considering all advantages of using a dictionary of distorted templates, there are still some limitations that need to be addressed: (i) computing frequency and orientation maps for input samples and comparing them with all samples in the dictionary takes a significant amount of time (from a second to several minutes depending on fingerprint properties); (ii) the performance of this method is related to the dictionary size, and increasing the dictionary size makes the recognition system slower; and iii) this method is highly dependent on computing the frequency and orientation maps of input samples which are not reliable due to the presence of distortion.

In this disclosure, the geometric distortion problem of fingerprint recognition systems is addressed by proposing a fast and effective distortion estimator which captures the non-linear properties of geometric distortion of fingerprints. A DCNN can be used to estimate the principal distortion components of input samples instead of handling distortion using a dictionary of distorted templates. This approach can offer the following contributions:
There is no need to estimate the ridge frequency and orientation maps of input fingerprints; and
Distortion parameters are being estimated continuously to achieve more accurate rectifications.
   In addition, there is notable decrease in rectification time due to embedding distortion templates in network parameters. The proposed approach will now be described, and experimental results will be presented.

DCNN-Based Distortion Estimation Model

The major limitation of the nearest neighbor rectification approach is related to identifying the nearest distorted template in a dictionary of distorted samples. Finding the nearest neighbor to the distorted input sample in the dictionary is not accurate due to unreliable frequency and orientation maps extracted from the input sample. Instead of using a dictionary of the ridge frequency and orientation maps of distortion templates, a DCNN can be used to estimate distortion parameter(s) of the input sample. In this way, the non-linear transformations that caused distorted templates can be learned by the deep neural network during the training phase.

The input to the network is the raw fingerprint image, and there is no need for computing the ridge frequency and orientation maps for the input samples. Contrary to the dictionary-based approach, the computational time of the proposed DCNN method for estimating the distortion for an input does not change by increasing the number of training samples since the network has a fixed number of parameters. On the other hand, the DCNN is capable of learning complex combinations of geometric distortions.

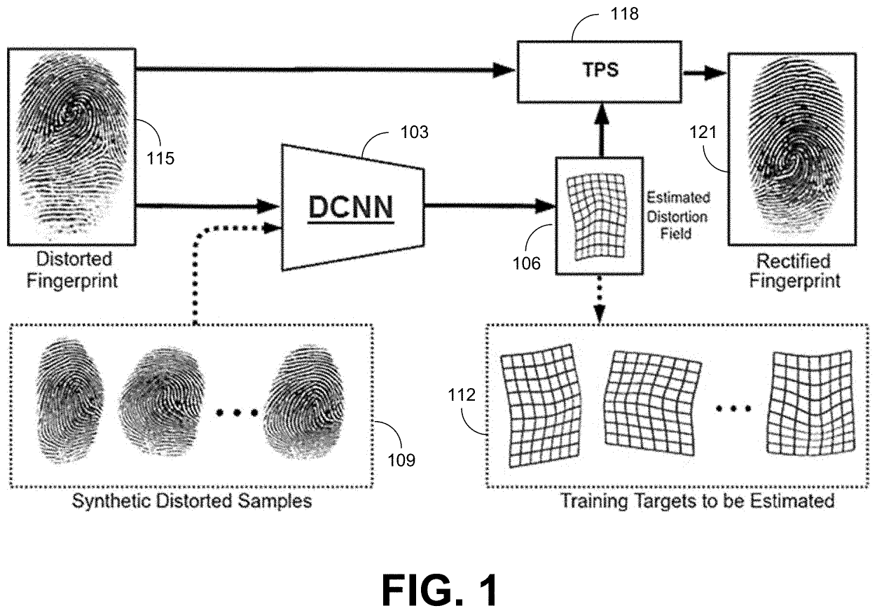

Referring to FIG. 1, shown is a flowchart depicting an example of a rectification scheme utilizing a DCNN 103. In the training phase, the DCNN 103 learns to estimate the distortion parameters of the estimated distortion field 106 of the input training images (e.g., synthetic distorted samples) 109 by minimizing the difference between the estimated parameters of the estimated distortion field 106 and the actual values of the corresponding training targets 112. In the testing phase, the DCNN 103 estimates distortion parameters by mapping the input fingerprint 115 to a non-linear manifold of distortion bases. Using the estimated distortion template 106 and the input fingerprint 115, it is possible to rectify the distorted fingerprint 115 by inverse TPS 118 or other appropriate geometric transformation of the distortion, thereby producing a rectified fingerprint 121.

Modeling Geometric Distortion to Generate Synthetic Distorted Fingerprints

Training a DCNN 103 utilizes a comprehensive database of labeled images. A synthetic database of distorted images 109 can be generated in order to train the DCNN 103. It is important to model distortion for this purpose. The Tsinghua distorted fingerprint database was used to statistically model geometric distortion. To extract displacement due to geometric distortion, minutiae pairs from the original and distorted fingerprint samples were matched. Minutia detection can be performed using, e.g., VeriFinger 7.0, a commercial fingerprint matching software. Since minutiae are anomalies in the fingerprint ridge map and have random positions, a similar grid of points can be defined to have a reference of distortion to be compared among different fingers.

Using sampling grid pairs from the original and distorted fingerprints, it is possible to represent distortion as a displacement of corresponding points on the original grid and the distorted grid as follows:

dᵢ=xᵢ^{D}−xᵢ^{N}, (1)

where dᵢ is the displacement of minutia for the ith pair of a distorted fingerprint (xᵢ^{D}) and the corresponding normal fingerprint (xᵢ^{N}). Using distortion samples of the Tsinghua database and computing the estimated distortion fields 106, it is possible to statistically model distortion by its principal components using principle component analysis (PCA). Approximation of distortion fields using PCA will be:

\hat{d}=d̅+Σᵢ₌₁^{t}cᵢ\sqrt{λᵢ}eᵢ. (2)

In equation (2), t is the number of selected principal components, cᵢ is the coefficient of the corresponding eigenvector component, eᵢ is ith eigenvector and λᵢ is its corresponding eigenvalue. The first two significant eigenvectors of distortion can be used to generate the synthetic samples.

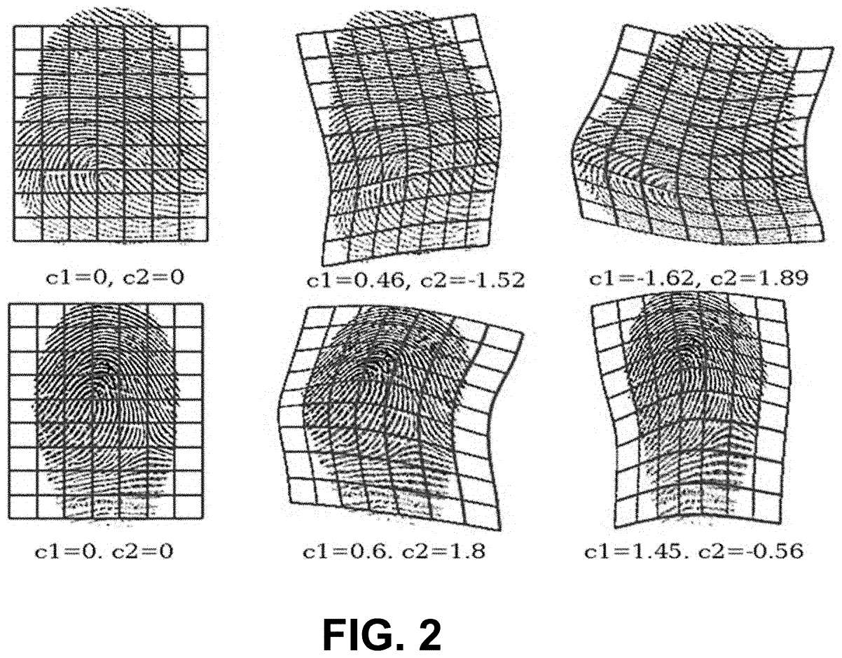

A dataset of synthetic distorted fingerprints was generated using 1033 normal fingerprints from the BioCOP 2013 dataset (VWU multimodal dataset, Biometrics and Identification Innovation Center. http://biic.wvu.edu/, which is hereby incorporated by reference in its entirety). Each normal fingerprint was transformed to 400 distorted images by sampling each of the two principal distortion components extracted from the Tsinghua database. Sampling was performed randomly with a uniform distribution between −2 and 2. The generated dataset has 1033×401=414,233 samples, in which each ID has one normal sample and 400 distorted samples. FIG. 2 shows examples of two synthetic distorted fingerprint samples generated for two different fingers for training the network. Each sample was generated by randomly sampling distortion bases c₁, c₂.

Network Architecture

A deep convolutional neural network (DCNN) 103 (FIG. 1) was used to learn the two eigenvector-based distortion coefficients. Compared to the fully connected networks, DCNNs are more robust against over-fitting due to weight sharing and fewer learning parameters. All layers are convolutional layers except the last one. The size of the input image to the DCNN 106 can be, e.g., 256×256×1 pixels (width×height×depth). Detailed properties of the network are shown in Table 1 below. The DCNN 106 comprises 9 convolutional blocks. Each layer, except the last one, comprises convolution (Conv), batch normalization (BN), rectified linear unit (ReLU) and max pooling (MP) with stride equal to two. All max pooling is 2×2 with a stride of two. All convolution strides are one, and all inputs to convolutions are padded to have the same size outputs.

TABLE 1
Architecture of the DCNN used for estimating the distortion fields.

| | | Kernel | Input | Output |
|---|---|---|---|---|
| Layer | Type | Size | Size | Size |
| 1 | Conv, BN, ReLU, MP | 3 × 3 × 32 | 256 × 256 × 1 | 128 × 128 × 32 |
| 2 | Conv, BN, ReLU, MP | 3 × 3 × 64 | 128 × 128 × 32 | 64 × 64 × 64 |
| 3 | Conv, BN, ReLU, MP | 3 × 3 × 64 | 64 × 64 × 64 | 32 × 32 × 64 |
| 4 | Conv, BN, ReLU, MP | 3 × 3 × 128 | 32 × 32 × 64 | 16 × 16 × 128 |
| 5 | Conv, BN, ReLU, MP | 3 × 3 × 256 | 16 × 16 × 128 | 8 × 8 × 256 |
| 6 | Conv, BN, ReLU, MP | 3 × 3 × 512 | 8 × 8 × 256 | 4 × 4 × 512 |
| 7 | Conv, BN, ReLU, MP | 3 × 3 × 1024 | 4 × 4 × 512 | 2 × 2 × 1024 |
| 8 | Conv, BN, ReLU, MP | 3 × 3 × 2048 | 2 × 2 × 1024 | 1 × 1 × 2048 |
| 9 | Conv | 1 × 1 × 2 | 1 × 1 × 2048 | 1 × 1 × 2 |

The DCNN 103 minimizes the norm-2 distance between ground truth coefficients (c₁ and c₂) and the DCNN outputs. For training the model, images are first centered according to the center of mass of the fingerprint area, and then scaled and the inputs cropped to a size of 256×256. A group of 401,000 synthetic distorted fingerprint images were used to train the model. The DCNN was trained over 40 epochs, each epoch consisting of 6,265 iterations with a batch size=64. Adam optimization method was used as the optimizer due to its fast convergence with beta=0.5 and learning rate=10⁻⁴.

Experimental Results

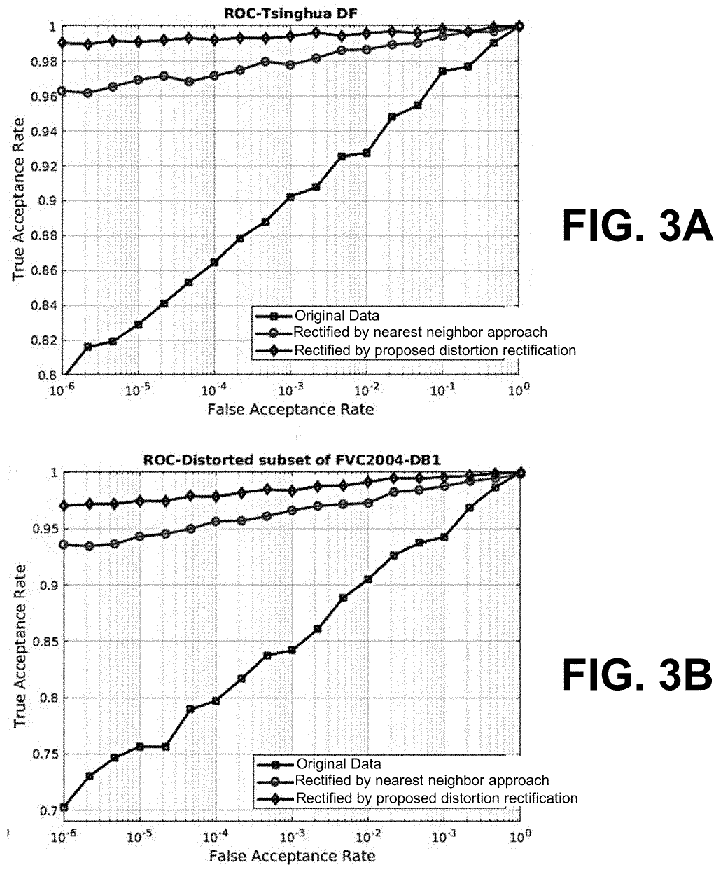

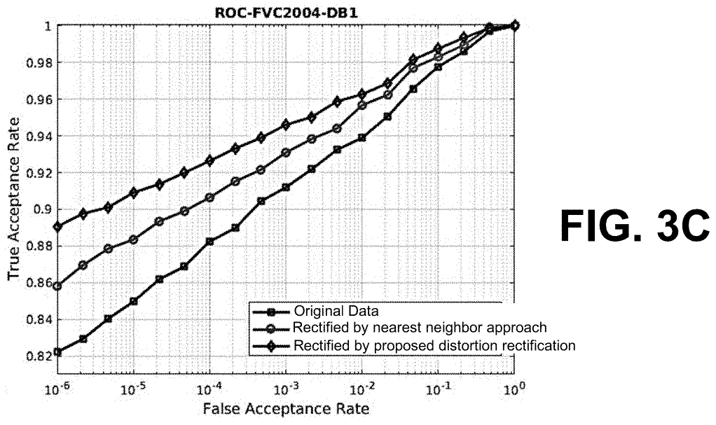

The first performance measure for evaluating the proposed distortion rectification using the DCNN is the overall matching performance. To evaluate the contribution of the proposed technology in improving matching performance, three experiments were conducted on each of the following three databases: FVC2004 DB1, distorted subset of FVC2004 DB1, and Tsinghua DF database. VeriFinger 7.0 was used to match fingerprint samples. The match score in each experiment was calculated for pairs of samples with the same ID, and no imposter pairs were conducted since the match score of VeriFinger is linked to the false acceptance rate (FAR). Higher match scores have a lower chance of falsely being accepted. In all three matching experiments, the first sample in each pair was a normal fingerprint without distortion, and the second one was the original distorted sample or the rectified sample. Rectification was performed both by the proposed DCNN distortion rectification methodology and the nearest neighbor rectification approach. ROC curves on three databases (Tsinghua DF database, a geometrically distorted subset of FVC2004 DB1, and FVC2004 DB1) are depicted in FIGS. 3A-30.

In the first experiment (FIG. 3A), samples from the Tsinghua DF database were rectified to evaluate the training procedure of the DCNN and the rectification performance. The Tsinghua DF database consisted of 320 pairs of normal and distorted fingerprints from 185 different fingers. Network training was performed using a synthetic distorted dataset generated by randomly sampling the first two significant principal components of the distortion manifold extracted from the Tsinghua DF database. Although the DCNN had never seen the original samples from the Tsinghua DF database during the training procedure, distortion components used to generate the synthetic dataset may bias the performance of the network. Therefore, matching performance was evaluated on a dataset containing only geometric distortion that is different from the Tsinghua DF database.

In the second experiment (FIG. 3B), a geometrically distorted subset of FVC2004 DB1 was used to evaluate the rectification performance of the proposed DCNN distortion rectification method. The distorted subset of FVC2004 DB1 contained 89 samples with skin distortions.

In the third experiment (FIG. 3C), FVC2004 DB1 was used to evaluate the rectification performance on a distorted database containing a variety of geometric and photometric distortions. The FVC2004 DB1 consisted of 110 classes and eight samples per class. Samples of each class were acquired by deliberately inducing photometric or geometric distortions. Since FVC2004 DB1 contains different distortion types, the proposed method targets only geometrically distorted samples and rejects other distortion types.

The quality of the rectified distorted samples depends on the performance of the distortion estimation. An experiment was conducted to compare distortion estimation of the proposed rectification using the DCNN 103 with the nearest neighbor method. The synthetic distorted database was generated using random sampling of the first two significant principal components. For comparison purposes, another distorted database was generated to compare distortion classification of the two methods. The proposed DCNN estimates continuous values of distortion basis. Therefore, the DCNN output was quantized to have 11 classes for each basis. In this order, class 1 is the first distortion basis with coefficient equal to −2.0, and class 11 is the first distortion basis with coefficient equal to 2.0.

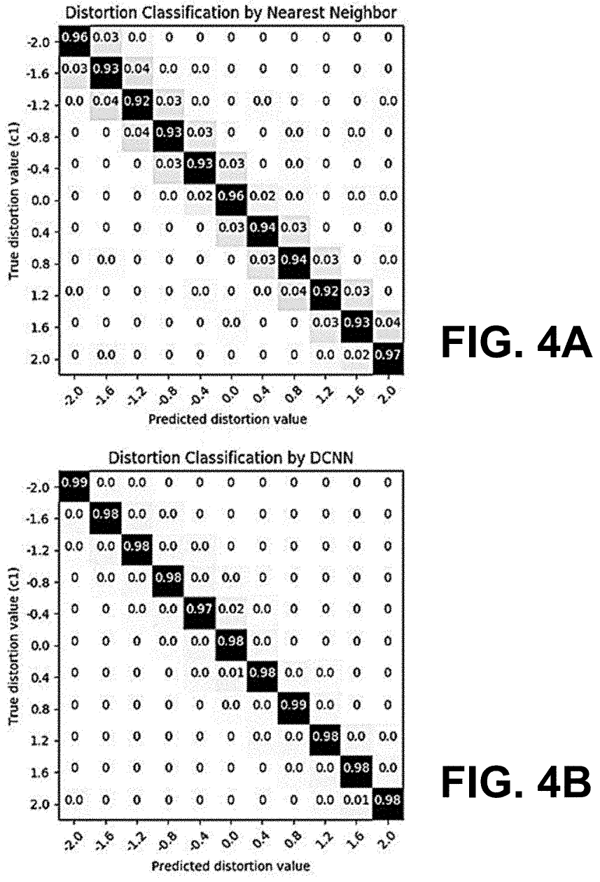

FIGS. 4A and 4B show the confusion matrices for the nearest neighbor and proposed DCNN methods of classifying the first basis, respectively. The distribution of diagonal values of the confusion matrix of FIG. 4B shows that the proposed DCNN is much more precise in estimating distortion coefficients. Although the nearest neighbor approach of FIG. 4A is not accurate enough, it contributes to distortion rectification since it finds the target distortion class with an error margin of approximately two classes.

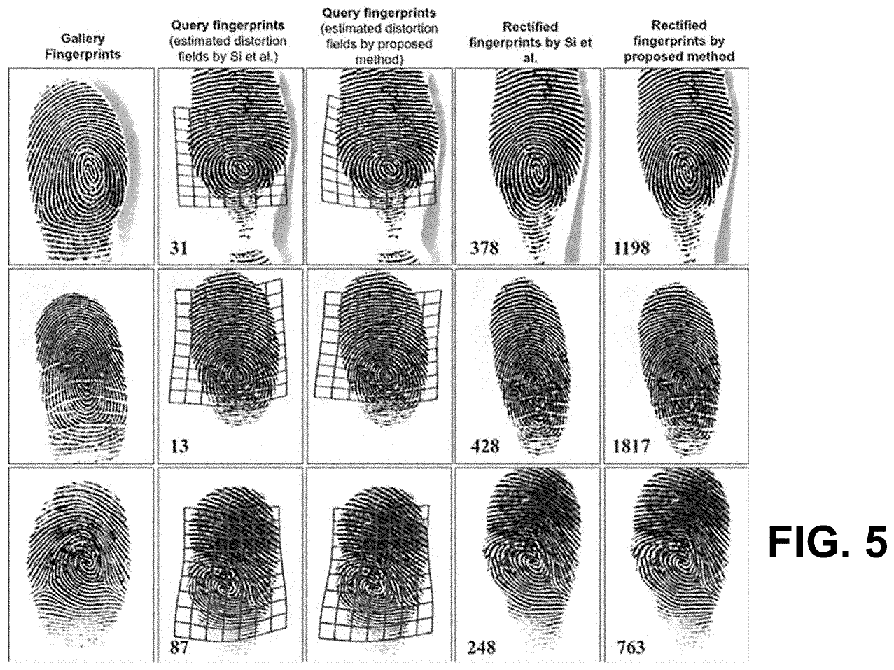

To compare the rectification results of the proposed DCNN distortion rectification approach and the nearest neighbor method, three examples from the Tsinghua DF database and FVC2004 DB1 are shown in FIG. 5. As can be seen in the right two columns, the rectified samples by both methods are very similar but the match score measurement indicates that there is a significant difference between them. A slight estimation error in distortion parameters prevents the spatial transformation from correctly restoring minutiae displacements.

In a fingerprint recognition system, distortion rectification is one of the preprocessing steps that can affect the total response time of the system. It is not possible nor efficient to use a computationally slow rectification method in a real-time recognition system since it brings inconvenience to users. Therefore, it is important to evaluate the rectification speed. Two experiments were conducted to evaluate the average response time of the rectification process on a PC with 3.3 GHz CPU and NIVDIA TITAN X GPU. Average time of distortion estimation results are illustrated in Table 2 below. From the average response time of the proposed DCNN approach and the matching experiments, it can be observed that utilizing the proposed DCNN as a distortion estimator, not only increases the accuracy of distortion detection, but also significantly reduces the detection time. The proposed DCNN distortion estimation is approximately 10 times faster than the nearest neighbor method.

TABLE 2
Average time of distortion estimation.

| | Time (sec) | |
|---|---|---|
| Method | Tsinghua DF | FVC2004 DB1 |
| Nearest Neighbor | 8.373 | 7.816 |
| Distortion estimation with DCNN | 0.741 | 0.736 |

One consideration is that the proposed DCNN distortion rectification algorithm was executed on the GPU, but the nearest neighbor method was executed on the CPU because it is not possible to implement a search method on parallel processors. Therefore, the reduction of the rectification time may be attributed to the capability of neural networks to embed training samples in the network parameters which enables conversion of a search problem to a direct prediction problem. Additionally, contrary to the nearest neighbor method, the response time of the proposed DCNN is independent of the properties of input samples to the network and guarantees an efficient lower bound for processing speed.

Geometric distortion significantly reduces the match score produced by a fingerprint verification system. In the positive recognition scenario, this causes inconvenience for users, but in the negative recognition scenario where users may intentionally distort their fingerprint, this can be considered as a security vulnerability. Therefore, distortion rectification can be implemented in order to prevent malicious users from hiding their identity, as well as reduce the inconvenience of using identification systems in authentication tasks. This disclosure described a novel approach to estimate distortion parameters from raw fingerprint images without computing the ridge frequency and orientation maps. A deep convolutional neural network (DCNN) is utilized to estimate distortion parameters of input samples. Distorted samples from the Tsinghua DF database and FVC2004 DB1 were successfully rectified using the estimated distortion template. A comprehensive database of distorted samples was generated in order to train the DCNN. Experimental results on several databases showed that the DCNN can estimate the non-linear distortions of samples more accurately than other methods. The DCNN distortion rectification method decreased rectification time significantly by embedding the training samples in the DCNN parameters. In addition, since the estimation time of the proposed DCNN distortion rectification method is independent of the training size, it is possible to increase the number of principal components which are used to generate the synthetic distorted database.

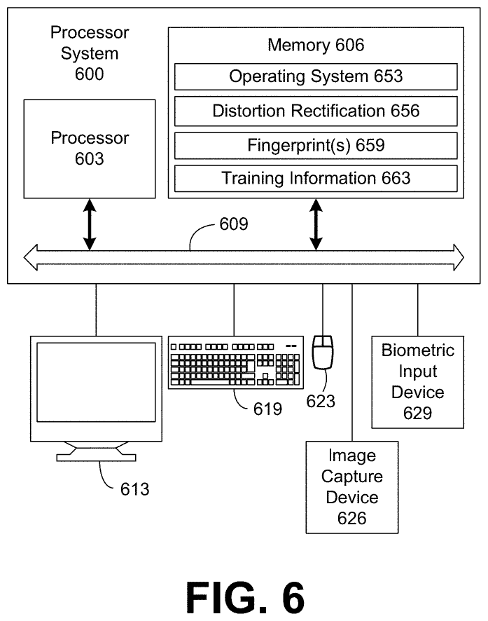

Referring next to FIG. 6, shown is one example of a system that performs various functions for fingerprint distortion rectification according to the various embodiments as set forth above. As shown, a processor system 600 is provided that includes processing circuitry having, e.g., a processor 603 and a memory 606, both of which are coupled to a local interface 609. The local interface 609 may be, for example, a data bus with an accompanying control/address bus as can be appreciated by those with ordinary skill in the art. The processor system 600 may comprise, for example, a computer system such as a server, desktop computer, laptop, smartphone, tablet, personal digital assistant, or other system with like capability.

Coupled to the processor system 600 can be various peripheral devices such as, for example, a display device 613, a keyboard 619, and a mouse 623. In addition, other peripheral devices that allow for the capture of various patterns may be coupled to the processor system 600 such as, for example, an image capture device 626, or a biometric input device 629. The image capture device 626 may comprise, for example, a digital camera or other such device that generates images that comprise patterns to be analyzed as described above. Also, the biometric input device 629 may comprise, for example, a fingerprint input device, optical scanner, or other biometric device 629 as can be appreciated.

Stored in the memory 606 and executed by the processor 603 are various components that provide various functionality according to the various embodiments of the present invention. In the example embodiment shown, stored in the memory 606 is an operating system 653 and a fingerprint distortion rectification application 656 that utilizes a DCCN. In addition, stored in the memory 606 are various fingerprint(s) 659 and various training information 663. The training information 663 can comprise, e.g., distortion parameters and/or training targets associated with corresponding distorted fingerprint(s) 659. The fingerprint(s) 659 and the training information 663 may be stored in a database to be accessed by the other systems as needed. The fingerprint(s) 659 can comprise fingerprint images or other patterns as can be appreciated. The fingerprint(s) 659 can comprise, for example, a digital representation of physical patterns or digital information such as data, etc.

The distortion rectification application 656 can be executed by the processor 603 in order to generate a rectified fingerprint as described above. A number of software components can be stored in the memory 606 and can be executed by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, or source code that may be expressed in proper format such as object code that is capable of being loaded into a of random access portion of the memory 606 and executed by the processor 603, etc. An executable program may be stored in any portion or component of the memory 606 including, for example, random access memory, read-only memory, a hard drive, compact disk (CD), floppy disk, or other memory components.

The memory 606 is defined herein as both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

The processor 603 may represent multiple processors and the memory 606 may represent multiple memories that operate in parallel. In such a case, the local interface 609 may be an appropriate network that facilitates communication between any two of the multiple processors, between any processor and any one of the memories, or between any two of the memories etc. The processor 603 may be of electrical, optical, or molecular construction, or of some other construction as can be appreciated by those with ordinary skill in the art.

The operating system 653 is executed to control the allocation and usage of hardware resources such as the memory, processing time and peripheral devices in the processor system 600. In this manner, the operating system 653 serves as the foundation on which applications depend as is generally known by those with ordinary skill in the art.

Although the distortion rectification application 656 can be embodied in software or code executed by general purpose hardware, as an alternative the same may also be embodied in dedicated hardware or a combination of software/general purpose hardware and dedicated hardware. If embodied in dedicated hardware, the distortion rectification application 656 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flowchart of FIG. 1 shows the architecture, functionality, and operation of an implementation of the distortion rectification application 656. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although flowchart of FIG. 1 shows a specific order of execution, it is understood that the order of execution may differ from that which is depicted. For example, the order of execution of two or more blocks may be scrambled relative to the order shown. Also, two or more blocks shown in succession in FIG. 1 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the distortion rectification application 656 may comprise software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the distortion rectification application 656 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for rectifying fingerprint distortion, comprising:
selecting an electronic, geometrically distorted fingerprint sample; and
generating a rectified fingerprint sample by rectifying geometric distortions from the electronic, geometrically distorted fingerprint sample by application of an estimated distortion field determined by a deep convolutional neural network (DCNN) trained previously on a database of synthetic, geometrically distorted fingerprint samples.

2. The method of claim 1, wherein the estimated distortion field is determined based upon distortion parameters estimated by the DCNN.

3. The method of claim 2, wherein the distortion parameters comprise two principal distortion components.

4. The method of claim 2, comprising estimating, by the DCNN, the distortion parameters from the electronic, geometrically distorted fingerprint sample.

5. The method of claim 1, wherein the rectified fingerprint sample is generated by an inverse geometric transformation based upon the estimated distortion field.

6. The method of claim 5, wherein the inverse geometric transformation is a thin plate spline (TPS) transformation.

7. The method of claim 5, wherein the rectified fingerprint sample is utilized for real-time recognition.

8. The method of claim 1, wherein the database of synthetic, geometrically distorted fingerprint samples is developed, at least in part, by randomly sampling distortion bases.

9. The method of claim 1, wherein the geometric distortions are generated by elastic deformations of human skin.

10. A system, comprising:
processing circuitry comprising a processor and memory; and
a distortion rectification application executable by the processing circuitry, where execution of the distortion rectification application causes the processing circuitry to:
identify distortion parameters associated with a distorted fingerprint, the distortion parameters estimated from the distorted fingerprint by a deep convolutional neural network (DCNN); and
generate a rectified fingerprint from the distorted fingerprint, the rectified fingerprint generated using an inverse geometric transformation based upon the identified distortion parameters.

11. The system of claim 10, wherein the distorted fingerprint is obtained by the system via a biometric input device.

12. The system of claim 11, wherein the distorted fingerprint comprises geometric distortions generated by elastic deformation of a finger.

13. The system of claim 10, wherein the distortion parameters comprise two principal distortion components estimated from the distorted fingerprint by the DCNN.

14. The system of claim 13, wherein the distortion parameters correspond to an estimated distortion field.

15. The system of claim 14, wherein the estimated distortion field is applied to the distorted fingerprint by the inverse geometric transformation.

16. The system of claim 10, wherein the inverse geometric transformation is a thin plate spline (TPS) transformation.

17. The system of claim 10, wherein the DCNN is trained using a database of distorted fingerprint images and corresponding training targets.

18. The system of claim 17, wherein the DCNN is trained by minimizing a difference between parameters estimated by the DCNN and actual values of the corresponding training targets.

19. The system of claim 17, wherein the distorted fingerprint images comprise synthetic distorted samples.

20. The system of claim 10, wherein the distortion rectification application causes the processing circuitry to provide the rectified fingerprint for real-time recognition.
